(19) United States
(12) Patent Application Publication
(10) Pub. No.: US 2004/0060413 A1
(43) Pub. Date: Apr. 1, 2004

(54) Dual-function citrus chopper

(76) Inventor: Emilio Martinez Simon, Albacete (ES)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/466,184

(22) PCT Filed: Apr. 25, 2002
(86) PCT No.: PCT/ES02/00201

(30) Foreign Application Priority Data
Apr. 25, 2001 (ES) P 200100965

(51) Int. Cl. B26D 1/00

(52) U.S. Cl. 83/651; 83/662

(57) ABSTRACT

The invention relates to a dual-function citrus fruit chopper comprising a common base plate (1) which supports a guide device (2). Said guide device comprises an arm (2.1) which is provided with a rounded end (2.1.1) and an upper extending concave part (2.1.2) and which moves and presses the citrus fruit (3) against another corresponding part (2.2) until it reaches the position where it is to be cut down the centre (3.1). A cutting element (4) is disposed next to the guide device (2) and is used to cut the citrus fruit into semi-circles (3.2) of equal thickness except for the two ends of said piece of fruit.

### OBJECT OF THE INVENTION

The invention herein propounded consists of a dual use citrus fruit slicer, of among the different devices for slicing this type of fruit.

This invention is characterised in a special construction of the slicer which has a common base, both for a guiding and securing device of lemons and which facilitates the manual partition thereof, cut in half and with no need to sustain them with the hand, as well as for another appended device which cuts the halves into a diversity of half-slices of equal thickness, plus two extreme half-caps which are discarded.

### BACKGROUND OF THE INVENTION

Machines exist for peeling, dividing into pieces and.extracting the juice from citrus fruits, one of which machines is even able to separate the juice from the essential oils of their skin.

The applicant is unaware of the existence of simple, manual means of widespread use which collaborate with the user when cutting the citrus fruit in halves and, then, dividing it into half-slices, having the characteristics of that are propounded hereunder.

### DESCRIPTION OF THE INVENTION

The invention object of the present specification relates to a dual purpose citrus fruit slicer, of among all those different devices for cutting by dividing this type of fruit into pieces.

This invention is characterised in a special construction of the slicer, not motor-driven and which has a common base, in the form of a supporting table for a guiding device for a piece, in a fishplate with rounded end and the edge of which is extended upwards in a concave piece that displaces the citrus fruit, for the purpose of securing the same against another antagonistic piece, the citrus fruit being pressed between the two, so that it facilitates the manual cutting of the latter, conventionally achieved with a knife or the like, with the object of sectioning it through the middle and without the user needing to sustain it with his hand during this cutting operation, with the consequent benefit of avoiding undesired cuts and without this signifying a loss of time with regard to conventional cutting by hand, which requires previous positioning and a slower cutting movement, for safety reasons.

Likewise, this table has another device appended to that for cutting into halves and which parts the latter into a diversity of half-slices of equal thickness, except for two extreme half-caps, which are discarded, whilst the half-slices are gathered up and employed separately for the habitual uses of the same.

To this end, this second device has a multiple grooved platform, of antagonistic admission of the edges of a multiplicity of blades arranged in parallel determining a grating, next to a piece for applying pressure, which is moved by a system of oblique parallel guides or of guide and cam, resting on, cutting and slicing in a multiple manner the half-citrus-fruit placed on the platform.

This piece for applying pressure, in a gantry arrangement formed by two end pieces in an inverted irregular U-shape and a transversal gripping piece, after cutting the citrus fruit into half-slices, gathers up all the centres thereof in its reverse path and, after returning to its starting position is raised above this and swivels about its lowermost end, until the half-slices fall by gravity on to the table itself or into a recipient mounted thereon, after which the extreme half-caps are removed and discarded by hand.

### DESCRIPTION OF THE DRAWINGS

The present descriptive specification is completed, with a set of drawings, which illustrate the preferred embodiment of the invention in a non-restrictive manner.

FIG. 1 shows the base table of the slicer, with the schematic layout of the slicer of citrus fruit into halves, on the left-hand side and of the slicer of half-slices, on the right-hand side.

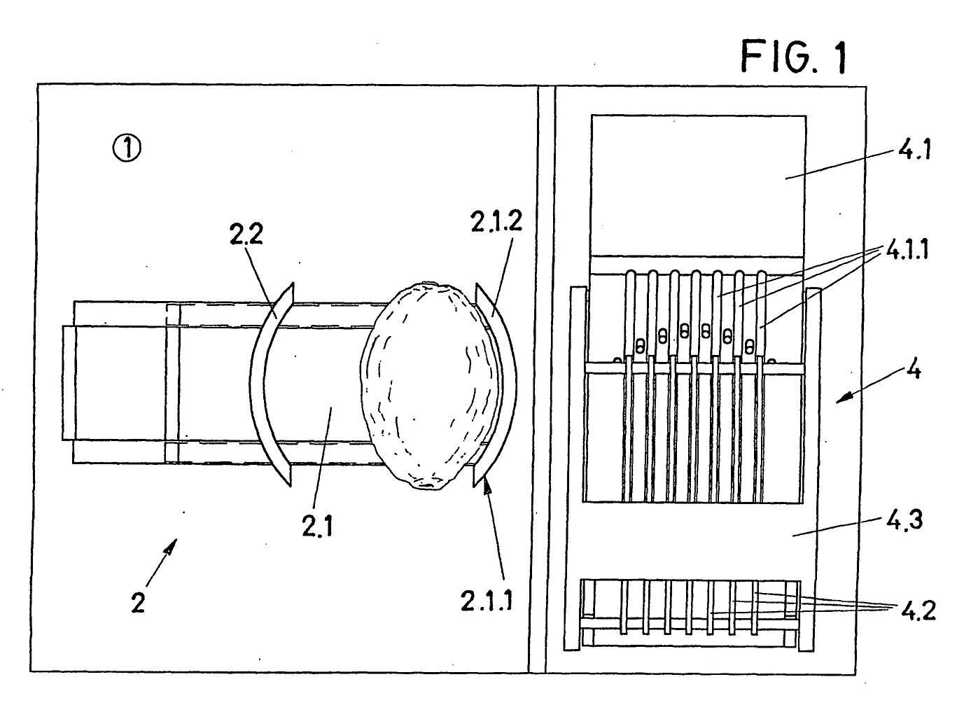

FIG. 2 shows the different positions of the device for cutting citrus fruit into halves, as well as some details of the guide track, as well as of the moveable pressing piece.

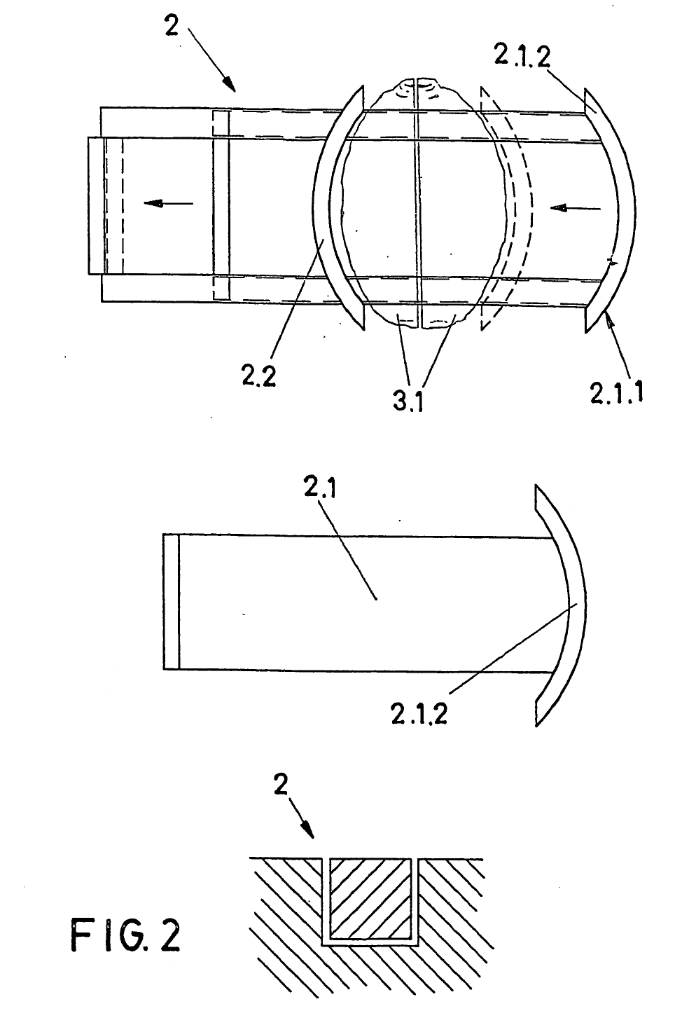

FIG. 3 shows a view in perspective of the device for cutting half-slices.

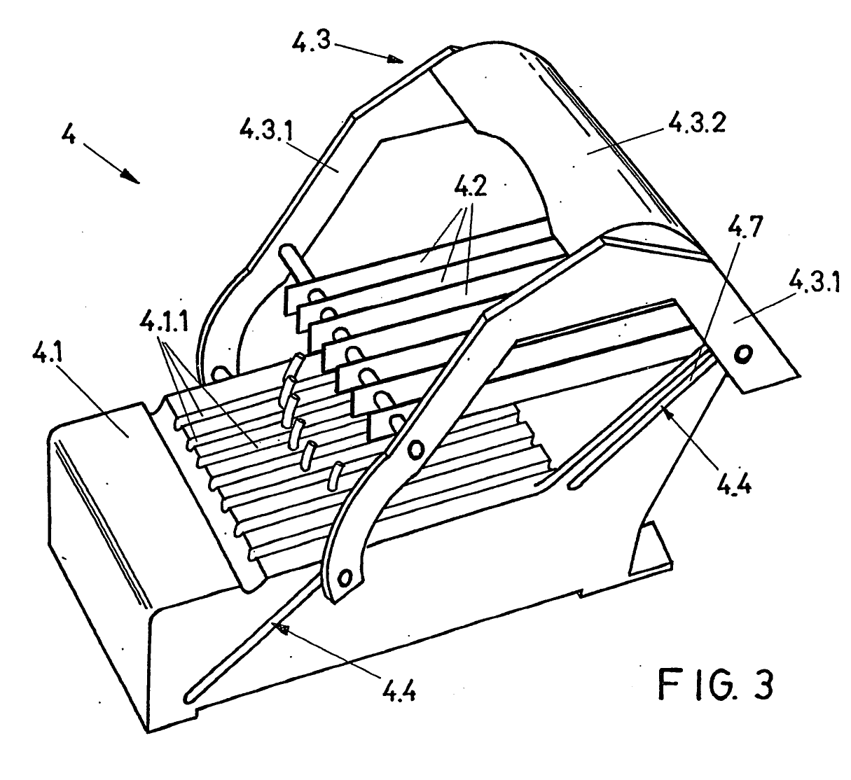

FIG. 4 shows a complete sequence of locating the half-piece of citrus fruit, of cutting the same into half-slices and of automatic ejection of the latter, by means of this same device of the previous figure.

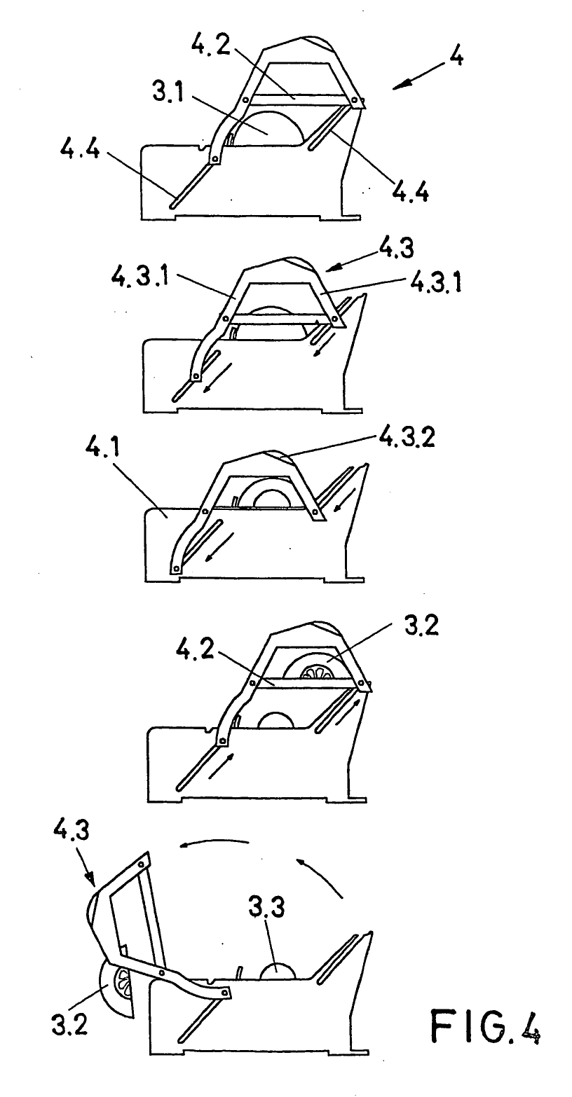

FIG. 5 shows another variant of this device for cutting in half-slices, by the guide and cam system, in identical cutting sequence.

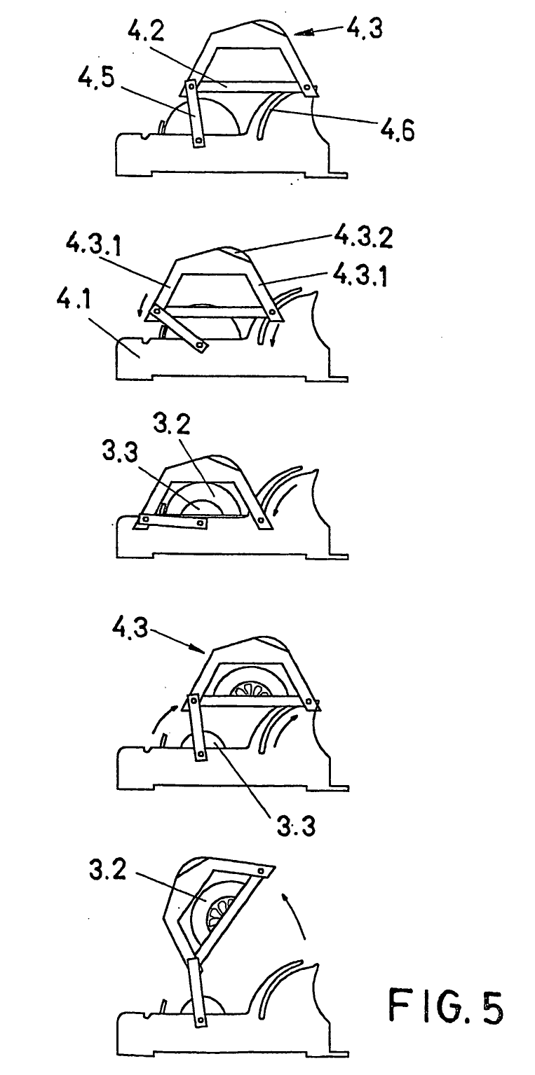

### PREFERRED EMBODIMENT OF THE INVENTION

In the light of the foregoing, the present invention relates to a dual purpose citrus fruit slicer, of among the different devices for cutting by dividing citrus fruit into pieces, essentially characterised in that it has a common base board (1), rectangular, securing a guiding device (2) constituted by a fishplate (2.1) of rounded end (2.1.1) and with upper extension in concave piece (2.1.2) which displaces and presses the citrus fruit (3), into its position of being cut in half (3.1), against another antagonistic piece (2.2).

Another device of the table (1), the slicer (4) of half-slices (3.2) of equal thickness, except for two residual extreme half-caps (3.3), has a platform (4.1), multiply grooved (4.1.1), of antagonistic admission of the edges of a multiplicity of blades (4.2) in grating arrangement, close to a piece for applying pressure (4.3) which is moved by a system of oblique parallel guides (4.4), resting on, cutting and slicing in a multiple manner the half-citrus fruit (3.1) deposited on the platform (4.1), this piece for applying pressure (4.3) being constituted in a gantry formed by two inverted irregular U-shapes (4.3.1) and a transversal piece (4.3.2) for gripping.

The piece for applying pressure (4.3), after cutting the half-citrus fruit (3.1) gathers up all the half-slices (3.2) in its reverse path, leaves its rear guide (4.4) and swivels on its front end until the half-slices (3.2) fall by gravity onto the table (1) or into an appropriate recipient, the end half-caps (3.3) being discarded by hand.

The relative position of the system of oblique parallel guides (4.4) is indifferent for functional effects, it being possible to align them in parallel or for any one of them to be displaced with respect to the other.

Likewise, the rear guide (4.4) can be substituted by the simple sliding of the rear end side which closes the grating arrangement of blades (4.2) with regard to the edge (4.7) of the slicer (4) of half-slices (3.2).

Also, in an alternative manner, the platform (4.1) multiple grooved (4.1.1) can have this grooved area staggered or the front end side of the grating arrangement of blades can be inserted in an antagonistic channel of the platform (4.1), to the same effect that the blades surpass the lower cutting edge of the half-slices (3.2), with the end that it can gather and rise up with all of them in its return path.

In a variant of the preferred embodiment, the two oblique guides (4.4) are substituted by the combination of a curved oblique guide (4.6) and a cam (4.5), with identical angular displacement in both elements of the piece for applying pressure (4.3).

The essential nature of this invention is not altered by variations in materials, form, size and arrangement of the component elements, described in a non-restrictive manner, this being sufficient for an expert to proceed to its reproduction.

1.- Dual purpose citrus fruit slicer, of among the different devices for cutting by dividing citrus fruits into pieces, essentially characterised in that it has a common base board (1), for supporting a guiding device (2) constituted by a plate (2.1) of rounded end (2.1.1) and with upper extension in a concave piece (2.1.2) which displaces and presses the citrus fruit (3), into its position of being cut in half (3.1), against an antagonistic other piece (2.2) as well as, abutting upon this guiding device (2), it has a slicing device (4) of half-slices (3.2) of equal thickness, except for two end half-caps (3.3), discarded.

2.- Dual purpose citrus fruit slicer, according to the previous claim, characterised in that the cutting device (4) has a platform (4.1) multiple grooved (4.1.1), of antagonistic admission of the edges of a multiplicity of blades (4.2) in grating arrangement, close to a piece for applying pressure (4.3) which is displaced by a system of oblique parallel guides (4.4), resting on, cutting and slicing in a multiple fashion the half-citrus fruit (3.1) deposited on the platform (4.1).

3.- Dual purpose citrus fruit slicer, according to the previous claims, characterised in that the piece applying pressure (4.3) is constituted in a gantry formed by two inverted irregular U-shapes (4.3.1) and a transversal piece (4.3.2) for gripping.

4.- Dual purpose citrus fruit slicer, according to the previous claims, characterised in that the piece applying pressure (4.3), after cutting the half citrus fruit (3.1), gathers up all the half-slices (3.2) in its reverse path, leaves its rear guide (4.4) and pivots about its front end until the half-slices (3.2) fall by gravity on to the table (1) or into an appropriate recipient, the end half-caps (3.3) being discarded manually.

5.- Dual purpose citrus fruit slicer, according to the previous claims, characterised in that the relative position of the oblique parallel guiding system (4.4) is indifferent for functional effects, either aligned in parallel or any one of them being displaced with regard to the other.

6.- Dual purpose citrus fruit slicer, according to the previous claims, characterised in the substitution of the rear guide (4.4) with the simple sliding of the rear end side, which closes the grating arrangement of blades (4.2), with respect to the edge (4.7) of the slicer (4) of half-slices (3.2).

7.- Dual purpose citrus fruit slicer, according to the previous claims, characterised in that the platform (4.1) multiple grooved (4.1.1) is mounted staggered in the area of grooves, for the purpose that the blades surpass the cutting lower edge of the half-slices (3.2), with the object that it can gather and rise up with all of them on its return path.

8.- Dual purpose citrus fruit slicer, according to the previous claims, characterised in that the front end side of the grating arrangement of blades can be inserted in an antagonistic channel of the platform (4.1), with the same object of gathering the half-slices (3.2) and rising up with them.

9.- Dual purpose citrus fruit slicer, according to the previous claims, characterised in the substitution of the oblique guides (4.4) with the combination of a curved oblique guide (4.6) and a cam (4.5), with identical angular displacement in both elements of the piece applying pressure (4.3).
